(19) United States
(12) Patent Application Publication
(10) Pub. No.: US 2008/0049382 A1
(43) Pub. Date: Feb. 28, 2008

(54) Method for producing substrate assembly for plasma display panel, and plasma display panel

(75) Inventor: Shigeo Kasahara, Tarumi-ku (JP)

Correspondence Address: MCDERMOTT WILL & EMERY LLP, 600 13TH STREET, N.W., WASHINGTON, DC, 20005-3096, US

(73) Assignee: FUJITSU HITACHI PLASMA DISPLAY LIMITED

(21) Appl. No.: 11/642,740

(22) Filed: Dec. 21, 2006

(30) Foreign Application Priority Data
Aug. 23, 2006 (JP) 2006-227001

(51) Int. Cl. B05D 3/00; H02B 1/015

(52) U.S. Cl. 361/600; 427/372.2

(57) ABSTRACT

A method for producing a substrate assembly for a plasma display panel includes the steps of applying a suspension to a dielectric layer covering display electrodes formed on a substrate, the suspension containing a dispersion medium and a large number of magnesium oxide crystals dispersed in the dispersion medium, and thereafter evaporating the dispersion medium to form a layer of the magnesium oxide crystals on the dielectric layer, wherein the dielectric layer has a rugged surface structure having uniformly-dispersed projections and depressions, the rugged surface structure being capable of trapping the magnesium oxide crystals.

### CROSS-REFERENCE TO RELATED APPLICATION

This application is related to Japanese Patent Application No. 2006-227001 filed on Aug. 23, 2006, whose priory is claimed and the disclosure of which is incorporated by reference in its entirety.

### BACKGROUND OF THE INVENTION

1. Field of the Invention

The invention relates to a method for producing a substrate assembly for a plasma display panel (hereinafter, referred to as PDP) and a PDP.

2. Description of the Related Art

FIG. 2 is a perspective view showing a structure of a conventional PDP. The PDP has a structure formed by sticking a front-side substrate assembly 1 and a rear-side substrate assembly 2 to each other. The front-side substrate assembly 1 comprises a front-side substrate 1a, which is a glass substrate, display electrodes 3 each composed of a transparent electrode 31 and a bus electrode 32 and arranged on the substrate 1a, and a dielectric layer 4 covering the display electrodes 3. Further, a protective layer 5, which is a magnesium oxide layer, with a high secondary electron emission coefficient is formed on the dielectric layer 4. In the rear-side substrate assembly 2, address electrodes 6 are arranged on a rear-side substrate 2a, which is a glass substrate, so that the address electrodes 6 cross at a right angle to the display electrodes 3, and barrier ribs 7 for defining the light emitting regions are formed between neighboring address electrodes 6 and red-, green-, and blue-emitting phosphor layers 8 are formed on the address electrodes 6 in the regions divided by the barrier ribs 7. A discharge gas, a Ne—Xe gas mixture, is introduced in air-tight discharge spaces formed in the insides between the front-side substrate assembly 1 and the rear-side substrate assembly 2 stuck to each other. It should be noted that the address electrodes 6 are covered with a dielectric layer (not shown) and the barrier ribs 7 and the phosphor layers 8 are formed on the dielectric layer.

In such a PDP, discharge for addressing (address discharge) is generated by applying voltage between the address electrodes 6 and the display electrodes 3, and reset discharge or sustain discharge for display is generated by applying voltage between a pair of display electrodes 3.

There is a slight time lag from the application of the voltage between electrodes to actual start of discharge between the electrodes and this time lag is called as discharge time-lag. If the discharge time-lag becomes significant, various kinds of undesirable phenomena such as deterioration of display quality, failure of correct display, and the like may be caused.

To improve the discharge time-lag, there is known a technique of forming a layer of magnesium oxide crystals on the dielectric layer covering the display electrodes (e.g., See Japanese Patent Application Laid-Open (JP-A) No. 2006-59786). According to JP-A No. 2006-59786, the magnesium oxide crystals is known to carry out cathode luminescence emission (hereinafter, referred to as CL emission) having a peak around 235 nm wavelength and a principle for improving the discharge time-lag is explained as follows. The magnesium oxide crystals have an energy level corresponding to 235 nm wavelength and trap electrons at the energy level for a long time (several msec) and emits the electrons when voltage is applied between the electrodes. Therefore, when voltage is applied between the electrodes, initial electrons necessary for discharge can be quickly supplied and as a result, the discharge time-lag can be improved.

The layer of the magnesium oxide crystals can be formed by a dry type application method such as an electrostatic application method and a wet type application method such as a spray method, a screen printing method, an off-set printing method, a dispenser method, an ink-jet method, or a roll coat method.

The wet type application method is more excellent than the dry type application method in terms of the firm adhesion of the magnesium oxide crystals to the dielectric layer.

### SUMMARY OF THE INVENTION

In the wet type application method, a layer of the magnesium oxide crystals is formed by applying a suspension obtained by dispersing magnesium oxide crystals in a dispersion medium to the dielectric layer and successively evaporating the dispersion medium. However according to this method, the layer of the magnesium oxide crystals sometimes cannot be formed evenly, because, at the time of evaporation of the dispersion medium, the magnesium oxide crystals can be agglomerated or the dispersion medium can be unevenly evaporated. In this case, the improvement effect of the discharge time-lag also becomes uneven and therefore it is desirable to evenly form the layer of the magnesium oxide crystals.

The present invention has been achieved in view of the aforementioned circumstances and provides a method for producing a substrate assembly for a PDP suitable for evenly forming a layer of magnesium oxide crystals on a dielectric layer covering display electrodes formed on a substrate.

The method for producing a substrate assembly for a PDP of the invention comprises the steps of applying a suspension to a dielectric layer covering display electrodes formed on a substrate, the suspension containing a dispersion medium and a large number of magnesium oxide crystals dispersed in the dispersion medium, and thereafter evaporating the dispersion medium to form a layer of the magnesium oxide crystals on the dielectric layer, wherein the dielectric layer has a rugged surface structure having uniformly-dispersed projections and depressions, the rugged surface structure being capable of trapping the magnesium oxide crystals.

According to the invention, when the suspension containing the magnesium oxide crystals is applied to the dielectric layer surface, the magnesium oxide crystals are trapped in the rugged surface structure formed uniformly in the dielectric layer surface and the dispersion medium of the suspension is evaporated in such a state, so that a layer of the magnesium oxide crystals can be evenly formed. Accordingly, a problem that the magnesium oxide crystals are agglomerated or that the dispersion medium is unevenly evaporated will not be caused.

### BRIEF DESCRIPTION OF THE DRAWINGS

FIGS. 1A to 1C are cross-sectional views showing the steps for producing a front-side substrate assembly for a PDP of an embodiment of the invention.

FIG. 2 is a perspective view showing a conventional PDP structure.

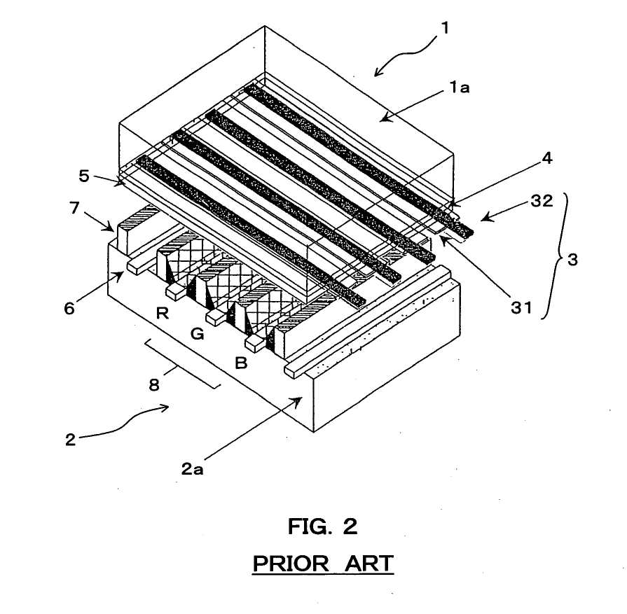

### DESCRIPTION OF THE PREFERRED EMBODIMENTS

Hereinafter, one embodiment of the invention will be described with reference of drawings. The configurations shown in the drawings or described below are only examples and accordingly, the invention is not to be considered as being limited by the drawings or the following descriptions.

In the following embodiment, the invention will be explained by exemplifying the case where display electrodes, a dielectric layer, and a layer of magnesium oxide crystals are provided in a front-side substrate assembly, however the case where display electrodes, a dielectric layer, and a layer of magnesium oxide crystals are provided in a rear-side substrate assembly is also included in the scope of the invention.

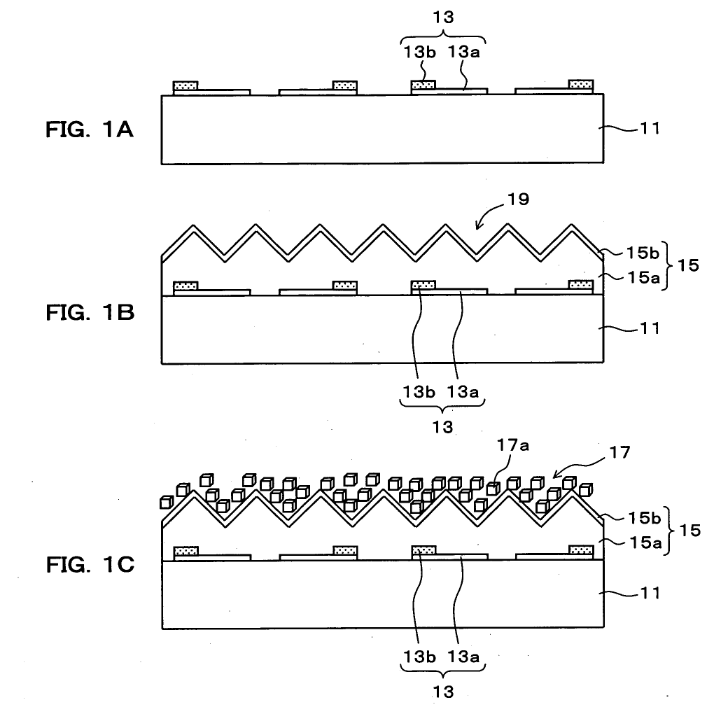

The method for producing the front-side substrate assembly for a PDP of an embodiment will be described with reference to FIGS. 1A to 1C. FIGS. 1A to 1C are cross-sectional views showing a method for producing the front-side substrate assembly for a PDP of the embodiment. The magnesium oxide crystals 17a are shown in the perspective view for drawing convenience.

As shown in FIGS. 1A to 1C, the method for producing the front-side substrate assembly for the PDP of the embodiment comprises the steps of applying a suspension to a dielectric layer 15 covering display electrodes 13 formed on a front-side substrate 11, the suspension containing a dispersion medium and a large number of magnesium oxide crystals 17a dispersed in the dispersion medium, and evaporating the dispersion medium to form a layer of the magnesium oxide crystals 17 on the dielectric layer 15, wherein the dielectric layer 15 has a rugged surface structure 19 having projections and depressions, the rugged surface structure being capable of trapping the magnesium oxide crystals 17a.

Hereinafter, the respective steps of the method of the embodiment will be described.

### 1. Step for Forming Display Electrode

First, as shown in FIG. 1A, the display electrodes 13 are formed on the front-side substrate 11.

The type of the front-side substrate 11 is not particularly limited and any kinds of substrates known in this field of the art can be employed. Specifically, transparent substrates such as a glass substrate, a plastic substrate, and the like can be exemplified.

As the display electrodes 13, electrodes made of transparent electrode materials such as ITO, SnO₂, and the like and electrodes made of metal electrode materials such as Ag, Au, Al, Cu, and Cr may be employed. Specifically, electrodes each composed of a transparent electrode 13a with a wide width of ITO, SnO₂, and the like and a bus electrode 13b with a narrow width made of a metal such as Ag, Au, Al, Cu, Cr and their laminate (e.g., Cr/Cu/Cr laminate structure) may be employed. A desired number of the display electrodes 13 with desired thickness, width, and intervals may be formed by employing a printing method for Ag and Au and combining a film formation method such as an evaporation method, a sputtering method, or the like with an etching method for the other materials.

### 2. Step for Forming Dielectric Layer

Next, as shown in FIG. 1B, the dielectric layer 15 covering the display electrodes 13 is formed on the obtained substrate. In the embodiment, the dielectric layer 15 has a double-layered structure and comprises an underlying dielectric layer 15a covering the display electrodes 13 and a magnesium oxide layer 15b covering the underlying dielectric layer 15a. The underlying dielectric layer 15a is formed by applying a paste for dielectric layer formation obtained by adding a binder and a solvent to low melting point glass frit to the obtained substrate by a screen printing method and firing the paste. The underlying dielectric layer 15a may be formed by depositing silicon oxide by a CVD method. The magnesium oxide layer 15b functions as a protective layer for protecting the underlying dielectric layer 15a and may be formed by an evaporation method or a sputtering method. Unlike a layer of magnesium oxide crystals 17 which will be described later, the magnesium oxide layer 15b formed by an evaporation method or a sputtering method generate no CL emission having the peak in a wavelength region from 200 to 300 nm (See. JP-A No. 2006-59786). It should be noted that the dielectric layer 15 may have a monolayer structure with the underlying dielectric layer 15a only (i.e. without magnesium oxide layer 15b).

The dielectric layer 15 has a rugged surface structure 19 having uniformly-dispersed projections and depressions, which is capable of trapping magnesium oxide crystals 17a. The shape of the rugged surface structure 19 is not particularly limited as long as it is capable of trapping the magnesium oxide crystals 17a. One example of the rugged surface structure 19 has a ten point average roughness Rz of 0.1 to 2 μm and a mean interval Sm of the projections and depressions of 0.2 to 40 μm. The roughness Rz and the mean interval Sm are defined by JIS B0601. Such a rugged surface structure 19 is preferred because it can efficiently trap the magnesium oxide crystals 17a. The ten point average roughness Rz and the mean interval Sm can be measured according to JIS B0633.

If the ten point average roughness Rz is too small, it becomes difficult to trap the magnesium oxide crystals 17a and if it is too high, the magnesium oxide crystals 17a are gathered in the depressions and accordingly, the density of the magnesium oxide crystals 17a becomes low in the projections. Accordingly, the ten point average roughness Rz is preferably in a range from 0.1 to 2 μm.

If the mean interval Sm is too small, it becomes difficult to trap the magnesium oxide crystals 17a and if it is too high, the effect of formation of the rugged surface structure 19 becomes slight. Accordingly, the mean interval Sm is preferably in a range from 0.2 to 40 μm.

Hereinafter, specific examples of a method for forming the rugged surface structure 19 will be described. However, the rugged surface structure 19 may be formed by a method other than the following exemplified methods.

### (1) Method by Sandblasting or Rubbing

In this method, at first, the underlying dielectric layer 15a with a flat surface is formed on a substrate by applying a paste for dielectric layer formation and firing the paste or by a CVD method after the step for forming display electrodes. Next, the rugged surface structure 19 having uniformly-dispersed projections and depressions is formed in the surface of the underlying dielectric layer 15a by sandblast or rubbing. The shape and size of the projections and depressions can be changed by changing the conditions of sandblasting (e.g., the size or the amount of the abrasive, the blasting time or speed, etc.) or the conditions of rubbing (e.g., the size or the amount of the abrasive, the rubbing time, pressure, or speed, etc.).

After the rugged surface structure 19 is formed on the underlying dielectric layer 15a, the magnesium oxide layer 15b covering the underlying dielectric layer 15a may be formed. The rugged surface structure 19 of the underlying dielectric layer 15a is reflected to the surface shape of the magnesium oxide layer 15b to form the rugged surface structure 19 also in the surface of the magnesium oxide layer 15b.

Herein, although the case where the magnesium oxide layer 15b is formed on the underlying dielectric layer 15a with the rugged surface structure 19 is exemplified for the explanation, the magnesium oxide layer 15b may be formed on the underlying dielectric layer 15a with a flat surface and then the rugged surface structure 19 having uniformly-dispersed projections and depressions may be formed in the surface of the magnesium oxide layer 15b by sandblasting or rubbing.

Further, the magnesium oxide layer 15b may be omitted to provide a single-layered dielectric layer 15 having the underlying dielectric layer 15a only.

### (2) Method of Using Paste for Dielectric Layer Formation with High Melting Point Material Particles Included

In this method, first, high melting point material particles of a material having a melting point higher than that of low melting point glass, for example, high melting point glass or oxides (alumina or magnesium oxide) are added to a paste for dielectric layer formation and the paste is applied to a substrate after the step for forming display electrodes and fired at a temperature at which the high melting point material particles are not melted. Accordingly, by the high melting point material particles, the underlying dielectric layer 15a having the rugged surface structure 19 having uniformly-dispersed projections and depressions is formed. The shape and the size of the projections and depressions may be changed by changing the size and number of the high melting point material particles. With regards to the formation of the magnesium oxide layer 15b after the formation of the rugged surface structure 19, the descriptions in the above method (1) is true of this method.

### (3) Method of Spraying High Melting Point Material Particles on Underlying Dielectric Layer

In this method, at first, the paste for dielectric layer formation is applied to a substrate after the step for forming display electrodes. Next, before firing the applied paste, high melting point material particles of a material having a melting point higher than low melting point glass, for example, high melting point glass or oxides (alumina or magnesium oxide) are sprayed to the paste and thereafter, firing is carried out. Accordingly, by the high melting point material particles, the underlying dielectric layer 15a having the rugged surface structure 19 having uniformly-dispersed projections and depressions is formed. The shape and the size of the projections and depressions may be changed by changing the size and number of the high melting point material particles. With regards to the formation of the magnesium oxide layer 15b after the formation of the rugged surface structure 19, the descriptions in the above method (1) is true of this method.

### 3. Step for Forming Layer of Magnesium Oxide Crystals

Next, as shown in FIG. 1C, a suspension obtained by dispersing a large number of magnesium oxide crystals 17a in a dispersion medium is applied to the dielectric layer 15 and thereafter, the dispersion medium is evaporated to form the layer of the magnesium oxide crystals 17 on the dielectric layer 15.

The size and the shape of the magnesium oxide crystals 17a are not particularly limited, however the average particle diameter is preferably in a range from 0.05 to 20 μm. If the average particle diameter of the magnesium oxide crystals 17a is too small, the CL emission with wavelength around 235 nm is weak and therefore, the effect to improve the discharge time-lag becomes slight and if the average particle diameter is too large, the magnesium oxide crystals 17 are difficult to be trapped in the rugged surface structure 19 in the surface of the dielectric layer 15 and therefore, it becomes difficult to uniformly form the layer of the magnesium oxide crystals 17.

The average particle diameter of the magnesium oxide crystals 17a can be calculated according to the following equation 1.

### Equation 1: average particle diameter=a/(S×p) (in the formula, the reference character “a” denotes a shape coefficient and 6; “S” denotes BET specific surface area measured by the nitrogen absorption method; and “p” denotes a true density of magnesium oxide).

The average particle diameter of the magnesium oxide crystals 17a may be specifically 0.05, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, and 20 μm. The range of the average particle diameter of the magnesium oxide crystals 17a may be in the range between two numerals specifically exemplified above.

A method for producing the magnesium oxide crystals 17a is not particularly limited, however it is preferable to produce them by a vapor phase method involving a reaction of magnesium vapor with oxygen and, for example, the production may be carried out specifically by a method described in JP-A No. 2004-182521 and a method described in “Synthesis of Magnesia Powder by Vapor Phase Method and Its Properties” in “Materials” vol. 36, no. 410, pp. 1157-1161, on November (1987). Further, the magnesium oxide crystals 17a may be bought from Ube Material Industries, Ltd. It is preferable to produce the crystals by a vapor phase method since single crystals with high purity can be obtained by this method.

The type of the dispersion medium to disperse the magnesium oxide crystals 17a therein is not particularly limited. The dispersion medium is preferably an alcohol in terms of the volatile property and especially preferably a lower alcohol with 1 to 5 carbon atoms.

The suspension may be produced by mixing and stirring the magnesium oxide crystals 17a with the dispersion medium.

Application of the suspension may be carried out by a wet application method such as a spray method, a screen printing method, an offset printing method, a dispenser method, an ink jet method, or a roll coat method.

If the suspension is applied to the dielectric layer 15 having the rugged surface structure 19 which can trap the magnesium oxide crystals 17a, the magnesium oxide crystals 17a in the suspension are trapped in the rugged surface structure 19 and made difficult to move in the direction parallel to the principal surface. If the dispersion medium is evaporated by decreasing the pressure or heating in such a state, the dispersion medium is removed without being accompanied with the agglomeration of the magnesium oxide crystals 17a and the layer of the magnesium oxide crystals 17 can be formed. Since the magnesium oxide crystals 17a are not agglomerated at the time of dispersion medium removal, the layer of the magnesium oxide crystals 17 can be formed uniformly.

Through the above-mentioned steps, the front-side substrate assembly can be formed. The front-side substrate assembly is stuck to a rear-side substrate assembly produced separately and having address electrodes, barrier ribs, and phosphor layers, to give a panel having air-tight discharge spaces in the inside. The front-side substrate assembly and the rear-side substrate assembly are stuck to each other in a manner that the display electrodes and the address electrodes cross at a right angle. The gas in discharge spaces of the panel is evacuated and thereafter, a discharge gas such as neon or xenon is introduced into the discharge spaces to produce a PDP. The PDP has a plurality of discharge cells disposed at the crossing points of the display electrodes and the address electrodes between the front-side substrate assembly and the rear-side substrate assembly.

Gas evacuation from the discharge spaces of the panel and introduction of the discharge gas into the discharge spaces are processes which take a long time, however since the front-side substrate assembly of this embodiment has the rugged surface structure 19 in the surface of the dielectric layer 15, gaps due to the rugged surface structure 19 are formed between the dielectric layer 15 of the front-side substrate assembly and the barrier ribs of the rear-side substrate assembly when the front-side substrate assembly and the rear-side substrate assembly are stuck to each other and accordingly, the gas evacuation conductance is improved and the time taken to evacuate the discharge spaces and introduce the discharge gas into the discharge spaces can be shortened.

The various characteristics described above in the embodiment may be combined properly. In the case a plurality of characteristics are included in one embodiment, one or a plurality of these characteristics may be properly extracted and employed alone or in combination for the invention.

What is claimed is:

1. A method for producing a substrate assembly for a plasma display panel comprising the steps of applying a suspension to a dielectric layer covering display electrodes formed on a substrate, the suspension containing a dispersion medium and a large number of magnesium oxide crystals dispersed in the dispersion medium, and
thereafter evaporating the dispersion medium to form a layer of the magnesium oxide crystals on the dielectric layer,
wherein the dielectric layer has a rugged surface structure having uniformly-dispersed projections and depressions, the rugged surface structure being capable of trapping the magnesium oxide crystals.

2. The method of claim 1, wherein the dielectric layer comprises an underlying dielectric layer covering the display electrodes and a magnesium oxide layer covering the underlying dielectric layer.

3. The method of claim 1, wherein the magnesium oxide crystals has an average particle diameter of 0.05 to 20 μm, the average particle diameter being calculated according to Equation 1.
Equation 1: average particle diameter=a/(S×p) (wherein, the reference character “a” denotes a shape coefficient and 6; “S” denotes BET specific surface area measured by the nitrogen absorption method; and “p” denotes a true density of magnesium oxide)

4. The method of claim 1, wherein the rugged surface structure has a ten point average roughness Rz of 0.1 to 2 μm and a mean interval Sm of the projections and depressions of 0.2 to 40 μm, the roughness Rz and the mean interval Sm being defined by JIS B0601.

5. The method of claim 1, wherein the rugged surface structure is formed by performing sandblasting or rubbing with regards to the surface of the dielectric layer.

6. The method of claim 1, wherein the rugged surface structure is formed by forming the dielectric layer by the steps of applying a paste to the substrate with the display electrodes formed thereon and performing firing of the paste,
the paste containing a low melting point glass and particles having a melting point higher than that of the low melting point glass, the firing being performed at a temperature where the low melting point glass melts and the particles do not melt.

7. The method of claim 1, wherein the rugged surface structure is formed by forming the dielectric layer by the steps of applying a paste to the substrate with the display electrodes formed thereon, spraying particles on the applied paste, and performing firing of the paste together with the particles,
the paste containing a low melting point glass, the particles having a melting point higher than that of the low melting point glass, the firing being performed at a temperature where the low melting point glass melts and the particles do not melt.

8. The method of claim 1, wherein the magnesium oxide crystals are formed by a vapor phase method involving a reaction of magnesium vapor with oxygen.

9. A plasma display panel comprising the substrate assembly of claim 1 disposed on the front side, and another substrate assembly disposed on the rear side, the latter substrate assembly having address electrodes on a substrate, the display electrodes and the address electrodes crossing at a right angle, the above two assemblies having a plurality of discharge cells therebetween, the discharge cells being disposed at the crossing points of the display electrodes and the address electrodes.
